(19) United States
(12) Patent Application Publication
(10) Pub. No.: US 2013/0019054 A1
(43) Pub. Date: Jan. 17, 2013

(54) FLASH MEMORY DEVICE AND METHOD PERFORMING ERASE OPERATION USING OVER PROGRAM

(71) Applicants: YOUNG-WOO JUNG, OSAN-SI (KR); HWAN-CHUNG KIM, NAMWON-SI (KR); HEE-TAK SHIN, HWASEONG-SI (KR); CHUN-SOO AHN, SUWON-SI (KR); JIN-WOO JUNG, SEOUL (KR)

(72) Inventors: YOUNG-WOO JUNG, OSAN-SI (KR); HWAN-CHUNG KIM, NAMWON-SI (KR); HEE-TAK SHIN, HWASEONG-SI (KR); CHUN-SOO AHN, SUWON-SI (KR); JIN-WOO JUNG, SEOUL (KR)

(73) Assignee: SAMSUNG ELECTRONICS CO., LTD., SUWON-SI (KR)

(21) Appl. No.: 13/466,429

(22) Filed: May 8, 2012

(30) Foreign Application Priority Data
Jul. 12, 2011 (KR) 10-2011-0068967

(51) Int. Cl. G06F 12/00

(52) U.S. Cl. 711/103; 711/E12.008

(57) ABSTRACT

A flash memory device performs an erase operation by execution of an over program. device. In response to an erase request directed to requested page data a logical page address is converted to a corresponding physical page address, an over program data pattern for an over program operation is generated, and the over program operation is executed using the PPA to change a threshold voltage distribution for at least one memory cell of the requested page data in accordance with the over program data pattern.

### CROSS-REFERENCE TO RELATED APPLICATIONS

This application claims the benefit of Korean Patent Application No. 10-2011-0068967 filed on Jul. 12, 2011, the subject matter of which is hereby incorporated by reference.

### BACKGROUND OF THE INVENTION

The inventive concept relates to flash memory devices and methods of operating same. More particularly, the inventive concept relates to flash memory devices capable of performing an erase operation by using an over program, and methods of operating such flash memory devices.

With the development of mobile electronic systems and other digital data systems and applications, the demand for flash memories has dramatically increased. Flash memory is a term used to describe certain electrically erasable and programmable non-volatile memory devices and related memory systems. Like all non-volatile memory devices, flash memory is able to retain stored data in the absence of applied power. Flash memory is further characterized by relatively low power consumption and faster data access speed when compared with other forms of non-volatile recording media such as magnetic disk memory, hard disk drives, etc.

Due to certain constituent operating characteristics, flash memory performs erase operations on a memory block by memory block basis (i.e., on a “block unit” basis). In contemporary flash memory devices, each memory block is a particular region of the much larger memory cell array and includes a plurality of pages. Thus, in order to erase one or more pages in any given memory block, a calculation—often referred to as a “copy-back calculation” must first be made. This copy-back calculation essentially determines how the “remaining pages” of the memory block (i.e., the pages of the memory block not being erased) will be copied and to which other memory block the remaining pages will be copied. For example, when pages to be erased are located in a single “selected” memory block, the erase operation may be performed by “copying back” the remaining pages of the selected memory block to one or more non-selected memory block(s). Following the copy-back operation, a physical erase operation may be performed on the selected memory block. Similarly, when pages to be erased are dispersed over a plurality of erase selected memory blocks, the collective remaining pages of the selected memory blocks may be copied back to one or more memory block(s), and then a physical erase operation may be performed on the group of selected memory blocks. This approach works relatively well, However, the overall time required to perform an erase operation is by the necessity of performing the copy-back operation prior to the physical erase operation.

Further, as is well understood by those skilled in the art, the operative lifetime of individual flash memory cells is largely determined by the number of physical erase operations that are performed on the memory block containing the memory cells. Thus, the useful lifetime of flash memory cells may be extended by suing techniques that avoid or minimize memory cell fatigue caused by repeated physical erase operations.

### SUMMARY OF THE INVENTION

The inventive concept provides a method of operating a flash memory device, the method comprising; receiving an erase request from an external host indicating requested page data, wherein at least a portion of the requested data page has been previously programmed, converting a logical page address (LPA) associated with the requested data page into a corresponding physical page address (PPA), generating an over program data pattern for an over program operation, and executing the over program operation on the requested data page using the PPA to change a threshold voltage distribution for at least one memory cell of the requested page data in accordance with the over program data pattern.

The inventive concept also provides a flash memory device comprising; a flash memory comprising a memory cell array of flash memory cell comprising a plurality of memory blocks, wherein each of the plurality of memory blocks comprises a plurality of pages, and a memory controller that receives an erase request includes a logical page address (LPA) from an external host indicating requested page data wherein at least a portion of the requested data page has been previously programmed in the memory cell array, generates a physical page address (PPA) corresponding to the LPA, determining an over program data pattern for an over program operation, and controlling the execution of the over program operation on the requested data page using the PPA to change a threshold voltage distribution for at least one memory cell of the requested page data in accordance with the over program data pattern.

### BRIEF DESCRIPTION OF THE DRAWINGS

Certain embodiments of the inventive concept will be described in some additional detail with reference to the accompanying drawings in which:

FIG. 1 is a block diagram of a flash memory device and a memory system including the flash memory device according to an embodiment of the inventive concept;

FIG. 2 is a block diagram further illustrating the flash memory device of FIG. 1;

FIG. 3 is a block diagram further describing one possible erase operation that may be performed on the flash memory device of FIG. 2;

FIG. 4 is a block diagram further describing an operation of reading a page that is over programmed according to an embodiment of the inventive concept;

FIGS. 5A and 5B are conceptual voltage diagrams illustrating threshold voltage distribution variations for memory cells of a page that is over programmed;

FIGS. 6A and 6B are conceptual diagrams that illustrate in an exemplary manner the status of memory blocks that perform an erase operation using an over program;

FIG. 7 is a flowchart summarizing a method of operating a flash memory device according to an embodiment of the inventive concept;

FIG. 8 is a flowchart summarizing a method of operating a flash memory device according to another embodiment of the inventive concept; and

FIG. 9 is a block diagram of a memory system including one or more flash memory device(s) consistent with an embodiment of the inventive concept.

### DETAILED DESCRIPTION

Certain embodiments of the inventive concept will now be described with reference to the accompanying drawings. The inventive concept may, however, be embodied in many different forms and should not be construed as being limited to only the illustrated embodiments. Rather, these embodiments are provided so that this disclosure will be thorough and complete, and will fully convey the concept of the inventive concept to those skilled in the art.

Throughout the drawings and written description, like reference numbers and labels are used to denote like or similar elements. As used herein, the term “and/or” includes any and all combinations of one or more of the associated listed items.

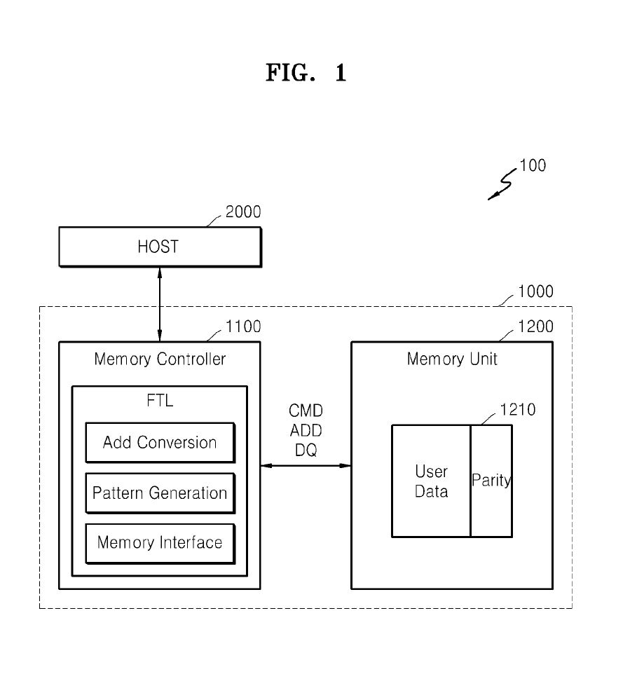

Figure (FIG. 1 is a block diagram of a flash memory device 1000 and a memory system 100 including the flash memory device 1000 according to an embodiment of the inventive concept. Referring to FIG. 1, the memory system 100 may include the flash memory device 1000 and a host 2000. The flash memory device 1000 may include a memory controller 1100 variously configured to control the overall operation of a memory unit (hereafter, a memory device, or simply, a memory) 1200 including the execution of program, read, and erase operation(s). The memory unit 1200 generally includes a memory cell region 1210 formed from an arrangement of flash memory cells. The cell region 1210 may include regions respectively designated to store user (or host application) defined data (“data”) as well as parity or other error correction code (“parity information”). The parity information may be generated when data is programmed to the memory cell region 1210. The parity information may be read together with identified data during a read operation. Those skilled in the art will recognize that the foregoing component and data designation and names are merely examples used to provide a descriptive predicate for the following embodiments of the inventive concept.

The memory controller 1100 and the memory unit 1200 may be embodied as separate semiconductor chips on a common substrate, or as completely separate semiconductor devices. Alternately, the memory system including the memory controller and the memory device may be embodied as a memory card, such as a secure digital (SD) card, a multimedia card (MMC), or the like.

The flash memory device 1000 and the host 2000 may communicate with each other by a standardized interface such as ATA, SATA, USB, SCSI, ESDI, PCE-express, or IDE interfaces. Other interface protocols and techniques that may be used in the context of memory systems consistent with embodiments of the inventive concept will be readily apparent to those skilled in the art. The host 2000 may be any device capable of using the flash memory device 1000 as a data storage medium, such as a personal digital assistance (PDA), a computer, a digital audio player, a digital camera, a mobile terminal, or the like.

With regard to the flash memory device 1000, program/read operations and the erase operation are performed according to different units, unlike other data storage device like the hard disk drive (HDD). In addition, since data cannot be directly overwritten in a memory cell region that has already been programmed, it is necessary to separately manage the program, read, and erase operations. Accordingly, a flash translation layer (FTL) is used. The FTL is a specialty program enabling the control and operation of the flash memory device 1000. In certain embodiments of the inventive concept, the FTL may be loaded to a predetermined random access memory (RAM) of the memory controller 1100 upon initialization of the memory system 100.

As shown in FIG. 1, the FTL usually includes a number of module(s) that collectively drive operation of the memory 1200. Such modules include; an address converting module that converts a logical address provided by the host 2000 into a corresponding physical address used to actually store data in the memory device 1200, a data pattern generating module that generates a data pattern during a memory operation and provides the data pattern to the memory 1200, and/or a flash memory interface module that controls access in variously forms (e.g., program, read, and erase operation access) to the memory 1200. When the host 2000 requests a memory operation, the memory controller 1100 may control the memory operation by loading the FTL to a RAM or a register under control of a processor (not shown) included in the memory controller 1100 and allowing the FTL to operate in response to the request from the host 2000.

The address converting module converts a logical address of a region to which the host 2000 requests access into a corresponding physical address. This address converting operation may be performed by a mapping operation of 1:1 mapping of logical addresses with corresponding physical addresses, and may use a mapping table to rapidly performing the mapping operation. The mapping table may be stored in metadata forms in a portion of the cell region 1210 of the memory 1200 and may be loaded to a RAM or a register of the memory controller 1100 during an operation of the flash memory device 1000.

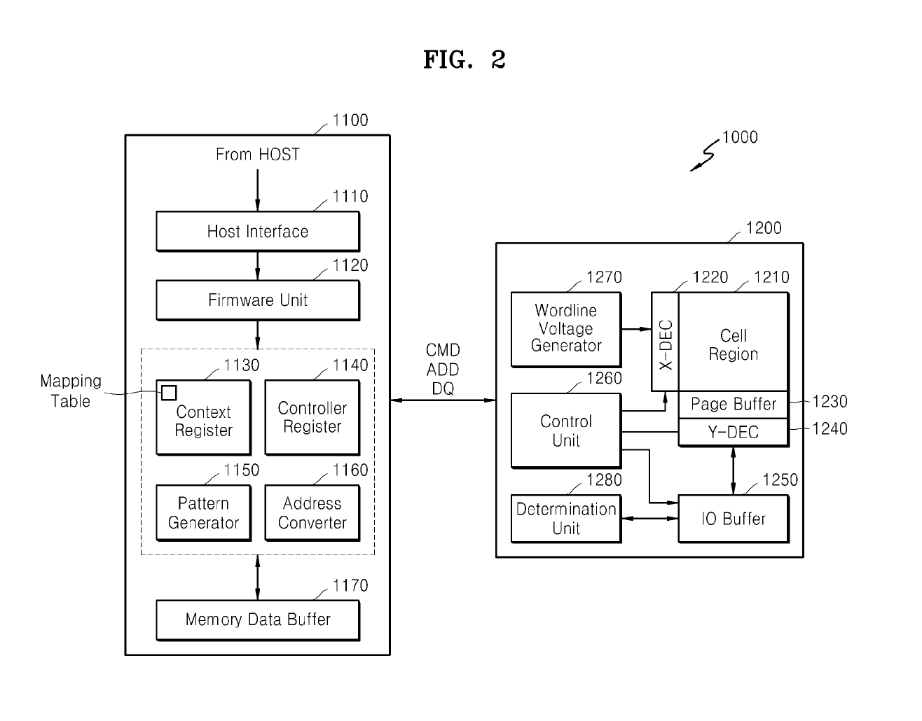

According to certain embodiments of the inventive concept, the data pattern generating module will generate an “over program data pattern” having a predetermined pattern during an erase operation and provide the over program data pattern to the memory 1200. In addition, the flash memory interface module generates a command causing the execution of an over program operation in response to an erase request from the host 2000. The command for performing the over program operation and the over program data pattern are then provided to the memory 1200. A physical address of a region where the over program is to be executed is provided to the memory 1200, wherein the physical address has been derived (or converted) from a logical address by the address converting module. The memory 1200 performs the over program operation using command, address, and/or data (hereafter, singularly and collectively referred to as “CAD”) information indicated in the illustrated embodiment of FIGS. 1 and 2 as command CMD, data DQ, and address ADD.

A page may be defined as a unit of the program and read operations of the flash memory device 1000. The page includes a plurality of flash memory cells commonly connected to a single word line. Certain embodiments of the inventive concept perform an over program operation on a page-by-page basis. Thus, a logical address and a corresponding physical address used during the over program operation may be defined as a logical page address (LPA) and a physical page address (PPA), respectively.

A somewhat more detailed description of the memory system 100 of FIG. 1 will now be given with reference to FIG. 2 taken in conjunction with FIG. 1. FIG. 2 is a block diagram further illustrating the flash memory device 1000 of FIG. 1 according to an embodiment of the inventive concept.

The memory controller 1100 generates various CAD signals that control program, read, and erase operations of the memory 1200 in response to a request of the host 2000. For example, the memory controller 1100 may provide the command CMD and the address ADD for performing the memory operation to the memory 1200 and may provide the data DQ to the memory 1200 during the program operation or may receive the data DQ read from the memory 1200 during the read operation. As further indicated in FIG. 2, a memory controller 1100 according to an embodiment of the inventive concept may include a host interface 1110, firmware unit 1120, a context register 1130, a controller register 1140, a pattern generator 1150, an address converter 1160, and a memory data buffer 1170.

The host interface 1110 interfaces with the host 2000 and receives a request for a memory operation from the host 2000. For example, the host interface 1110 receives various requests for program, read, erase, move, and recover of data from the host 2000 and generates various internal signals for an operation of the memory controller 1100 in response to the requests. The firmware unit 1120 may include software including an FTL and may be embodied as a memory such as a RAM storing the FTL. The firmware unit 1120 controls an overall operation of the memory controller 1100 by using the various internal signals generated by the host interface 1110.

The firmware unit 1120 requires predetermined information in order to perform the memory operation. The information may be referred to as context information. The context information may include mapping information for managing an address of the memory 1200, caching information that is required according to an interfacing speed difference between a volatile memory and a nonvolatile memory. The context register 1130 may store the context information. The firmware unit 1120 may update context information for the memory operation.

In addition, the firmware unit 1120 sets the controller register 1140 to store various control signals for the memory operation in the controller register 1140. For example, the various control signals to be provided to the memory 1200 are set to the controller register 1140 when a request for an erase operation of data is received from the host 2000. In addition, under control of the firmware unit 1120, the pattern generator 1150 generates a data pattern to be used in the over program operation for erasing data and the memory data buffer 1170 stores the data pattern generated by the pattern generator 1150. The address converter 1160 converts a logical address into a physical address by using a mapping table including mapping data. In order to perform this address converting operation, as described above, if the mapping data (or the mapping table) is stored in the context register 1130, the address converter 1160 may perform the address converting operation with reference to the context register 1130. The mapping data for performing the address converting operation may be embodied in various forms. For example, when the address converting operation is performed on a page-by-page basis, the address converter 1160 converts the LPA into the PPA by using mapping data indicating a mapping relationship between the LPA and a PPA.

The memory 1200 may include the cell region 1210 on which a plurality of flash memory cells are arranged, a row decoder 1220, a page buffer 1230, a column decoder 1240, an input/output (IO) buffer 1250, a control unit 1260, a word line voltage generator 1270, and a determination unit 1280. The cell region 1210 may include at least one memory block. The memory block may be defined as an erase unit of the flash memory device 1000. The memory block may include a plurality of pages and may include a data region for storing user data and a parity region for storing parity information used to detect and correct errors.

The memory 1200 performs the memory operation in response to the CAD information (e.g., the command CMD, address ADD, and data DQ) received form the memory controller 1100. The control unit 1260 controls various operations of the memory 1200. The row decoder 1220 is connected to the cell region 1210 through word lines and drives a selected word line in response to a row address and non-selected word lines by word line voltages that respectively correspond to the row address and the non-selected word lines. The column decoder 1240 selects data latched by the page buffer 1230 in response to a column address and transmits the data to the IO buffer 1250, or provides data stored in the IO buffer 1250 to the page buffer 1230. The IO buffer 1250 stores the data DQ provided from the memory controller 1100 or transmits data read from the cell region 1210 to the memory controller 1100.

The word line voltage generator 1270 generates a word line voltage for various operations such as program, read, and erase operations and provides the word line voltage to the row decoder 1220. The determination unit 1280 detects whether an error exists in the data read from the cell region 1210 and determines whether a corresponding read operation has failed or passed. The cell region 1210 may store data and parity information. The determination unit 1280 may determined whether the read operation has failed or passed by using the read data and parity information.

A data erase operation of a flash memory is classified into a physical erase operation of applying an erase voltage Verase with a high voltage level to a substrate of the cell region 1210 of the memory 1200 and a logical erase operation of erasing mapping data of a mapping table in response to an erase request from an external host when the flash memory device 1000 is embodied as a system such as a memory card. In order to provide improved information security, a method (hereafter a “security erase operation”) is provided by certain embodiments of the inventive concept in which data is physically erased in response to an erase request from a host, even in a system such as a memory card, so that data may not be read from external systems. According to certain embodiments of the inventive concept, methods and apparatuses are provided that reduce memory cell fatigue in the flash memory, and also reduce the time required to execute erase operations, including security erase operations.

According to the embodiments illustrated in FIGS. 1 and 2, the flash memory device 1000 may perform an erase operation upon receiving an erase request directed to “requested page data” (i.e., data including one or pages as indicated by a corresponding CAD information of an erase request) from the host 2000 and by thereafter over programming the “requested page data” of the memory 1200 in response to the erase request.

The over program operation may be defined as an operation that again performs a program operation directed to requested page data that has previously been programmed, and is therefore not usually subject to a “direct” programming operation. That is, it would normally require a memory bock copy-back operation and a physical erase operation before being re-programmed by an applied program operation. When the erase request and the LPA for the requested page data to be erased are received from the host 2000, CAD signals that cause execution of the over program operation are set in response thereto in the controller register 1140 under the control of the firmware 1120. An over program data pattern to be used during the over program operation is then generated by the pattern generator 1150 and stored in the memory data buffer 1170. The LPA is converted into a corresponding PPA using, for example, mapping data stored in a mapping table.

Through the above-described operations, the memory controller 1100 generates CAD information (e.g., a command CMD causing execution of the over program operation, an address ADD indicating the PPA for the requested page data to be over programmed, and a desired over program data pattern DQ). This CAD information is provided to the memory 1200 in response to the erase request received from the host 2000. After the memory 1200 executes the over program, mapping data related to the LPA of requested page data to which the over program operation was directed will be updated in the mapping table.

The memory 1200 receives the command CMD, the address ADD, and the data pattern DQ from the memory controller 1100 and performs the memory operation corresponding to the command CMD, the address ADD, and the data pattern DQ. The control unit 1260 decodes the command CMD for executing the over program to generate control signals for controlling an internal structure of the memory 1200. The row decoder 1220 decodes the address ADD to select a page to be over programmed. The data pattern DQ is provided to the page buffer 1230 through the IO buffer 1250 and the column decoder 1240. The word line voltage generator 1270 generates various word line voltages for performing the memory operation. During the over program operation, a voltage applied to a word line of the cell region 1210 may have the same level as a word line voltage that is provided during a program operation. For example, a program voltage Vpgm may be applied to a selected word line associated with the requested page data and a pass voltage Vpass may be applied to word lines associated with other non-selected word lines.

In the flash memory device 1000 according to the embodiment illustrated in FIGS. 1 and 2, certain requested page data identified in the cell region 1210 may be effectively (and directly) erased by executing the over program on a page basis, rather than being physically erased in a memory block unit in response to a received erase request. That is, a threshold voltage distribution for memory cells for the requested page data may be changed by essentially re-programming the memory cells using a predetermined over program data pattern. However, due to the use of different threshold voltage distributions, it is often impossible to recover data from a page wherein one or more threshold voltage distributions have been changed. For example, even if the data and parity information for a particular many be read, if the data and/or the parity information are changed, the originally programmed data cannot be properly read. Hence, when the determination unit 1280 receives the data of the requested page data to be over programmed along with its parity information, the determination unit 1280 will determine that the data obtained by a read operation has failed.

The over program method described above may be used in conjunction with single level memory cells (SLC) or multi-level memory cells (MLC). According to embodiments of the present embodiment, an erase operation performed using an over program method effectively avoids the physical erase operation typically associated with the update of previously programmed flash memory cells. By avoiding this physical erase operation, flash memory cell fatigue is reduced, thereby extending the lifetime of the constituent flash memory. Further, since the copy-back operation may also be omitted, the time required to perform the erase operation may be reduced.

FIG. 3 is a block diagram further describing the execution of an erase operation by the flash memory device 1000 of FIG. 2 according to an embodiment of the inventive concept. Referring to FIG. 3, the memory controller 1100 receives an erase request signal (Req_Erase) directed to requested page data stored in the memory 1200 from the host 2000. The erase request signal (Req_Erase) may include at least one LPA associated with the requested page data to be erased.

In response, the memory controller 1100 provides an over program command (CMD_OP) to the memory 1200 in order to perform the erase operation. The over program command (CMD_OP) may be defied with substantially same combination of one or more instructions as a general program command. The LPA for the requested page data to be over programmed is converted then into a corresponding PPA and provided to the memory 1200. A data pattern (DQ_pat) predetermined for the over program operation (or defined in relation to the requested page data) is generated and provided to the memory 1200.

The memory 1200 then applies a word line voltage for performing the over program operation to a word line of a page corresponding to the PPA and provides the data pattern DQ_pat to a selected page so as to over program the page. Prior to the over program operation, the memory cells of the requested page data have threshold voltage distribution(s) according to previously applied program operations. As the over program is executed according to the data pattern DQ_pat, these (potentially random) threshold voltage distribution(s) are changed by the over program operation. In this manner, the over program operation is “directly” performed on the memory cells associated with the requested page data without requirement of an intervening copy-back operation and/or physical erasing operation.

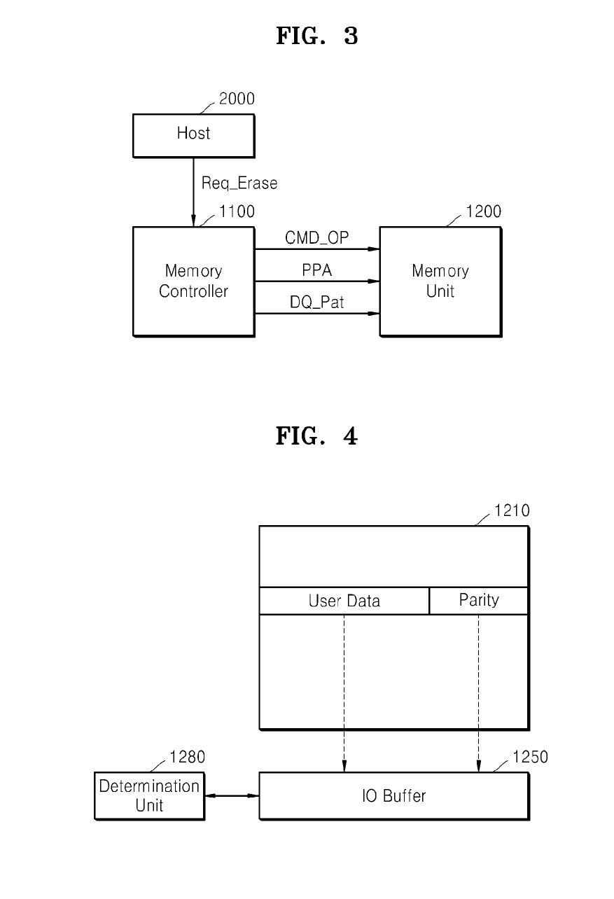

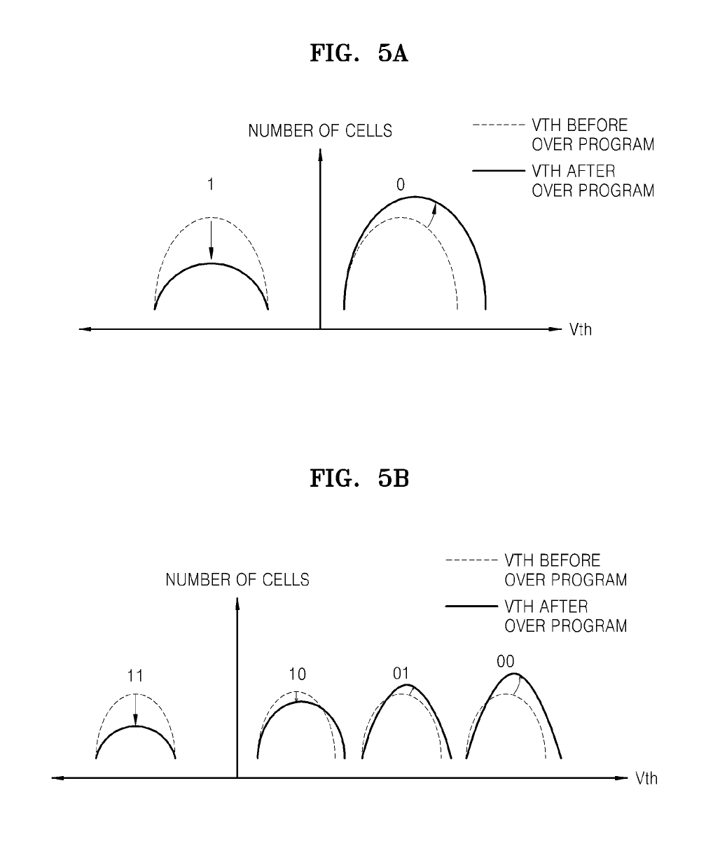

FIG. 4 is a block diagram further describing a read operation for a page that has been previously over programmed according to an embodiment of the inventive concept. FIGS. 5A and 5B are conceptual diagrams illustrating a change in threshold voltage distributions for requested page data that has been over programmed.

As shown in FIG. 4, an over program operation consistent with an embodiment of the inventive concept may be performed on a page basis. The over program operation may be performed on a region for storing user data such as a text of a page, an image, a voice, or the like and a region for storing information (i.e., parity information) related to the user data. Flash memory cells associated with the requested page data have threshold voltage distribution(s) (as well as corresponding parity information0 that is defined by previously applied program operations. Such threshold voltage distribution(s) will be changed by application of the over program operation. Data patterns for executing the over program may be generated as patterns that are previously stored by a memory controller or may be generated to have different values according to respective over programs.

As the over program is executed, the stored data value for flash memory cells of the requested page data (including user data and/or parity information) is changed. Accordingly, the previously established parity (or particular ECC) relationship between the data and the parity information is lost due to subsequent application of the over programmed page. However, the data and parity information read from the requested data page following the over programming of the requested data page will still be provided to the determination unit 1280 through the IO buffer 1250 during a read operation. And the determination unit 1280 will perform a predetermined verification operation using the received data and parity information. Quite predictably, therefore, the determination unit 1280 will determine that the read operation is “failed” due to the absence in parity correlation between the data and the parity information, and will accordingly generate a failure indication.

FIG. 5A shows the result of an over program executed on a SLC in a requested page data. Prior to the execution of the over program, the threshold voltage distributions are assumed to have the shapes indicated by the dashed lines. According to a status that is previously programmed, some flash cells of the page have a data value of “1” and the other remaining flash cells of the page have a data value of “0”.

As the over program is executed, voltage levels of threshold voltages of some cells of the page are increased and thus, as indicated by solid lines, the threshold voltage distribution of the page changes into a different form than that of data that is originally programmed. For example, as indicated by a solid line, the data value of at least some flash cells from among the flash cells with a data value “1”, which have a relatively low threshold voltage, may be changed by the over program. In addition, threshold voltages of at least some flash cells from among the flash cells with a data value “0”, which have a relatively high threshold voltage, may be increased by the over program. That is, the previously programmed data is changed by the applied over program operation and thus the parity information related to the data is also changed. When attempts are made to subsequently read the requested page data, the resulting data cannot be properly read since the data and its corresponding parity information are no longer properly related.

FIG. 5B shows the result of an over program executed on a MLC of a requested page data. Referring to FIG. 5B, prior to the execution of the over program, threshold voltage distribution may have shapes indicated by dashed lines. According to a status that is previously programmed, flash cells may have threshold voltages corresponding to data values of “11”, “10”, “01”, and “00”, respectively. In addition, as the over program is executed, the number of flash cells having data values of “11” and “10” is reduced in the page. On the other hand, the number of flash cells having data values of “01” and “00” is increased.

As the over program is executed, voltage levels of threshold voltages of at least some flash cells of the page are increased and thus a threshold voltage distribution of the page is changed. Since the MLC stores any one data value from among various data values according to a threshold voltage level, user data and parity information is more changed by the over program operation than in the case of the SLC. Also in the case of the MLC, as user data and parity information are changed, the determination unit 1280 determines that the read operation has failed with respect to the data read from the page.

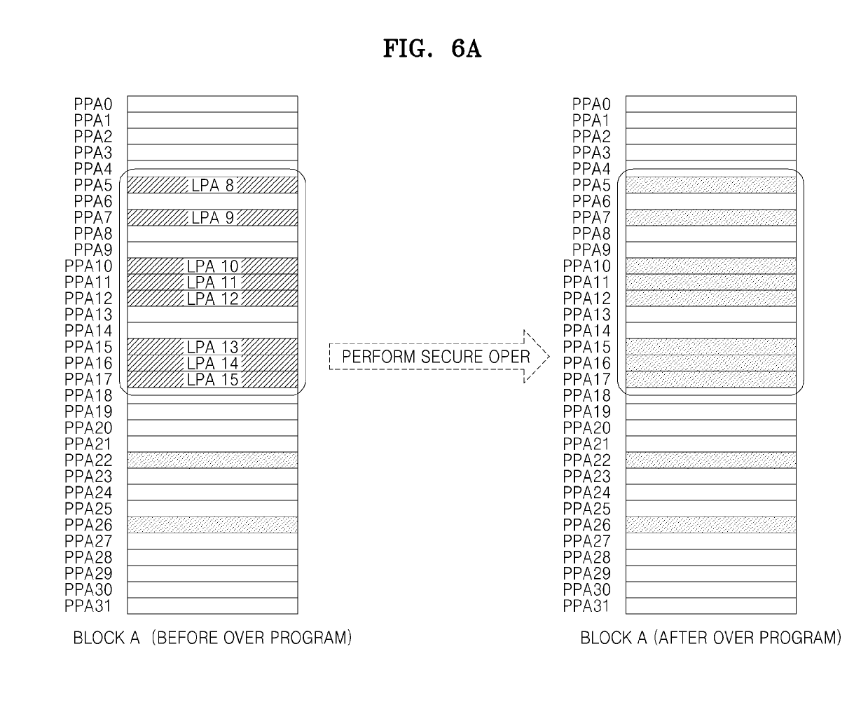

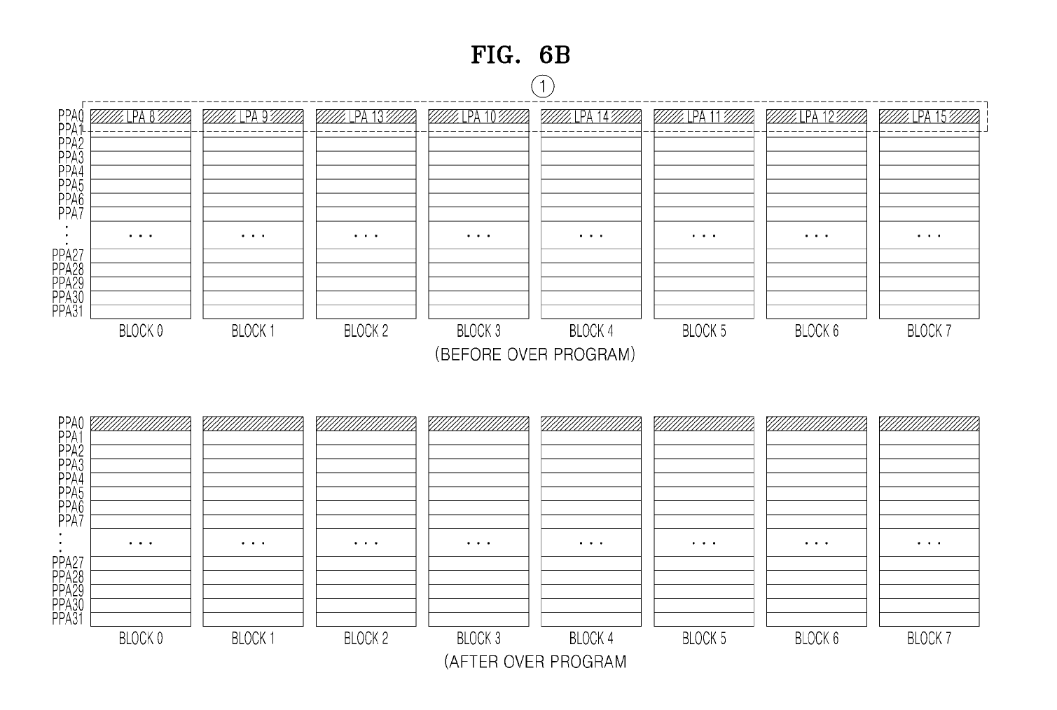

FIGS. 6A and 6B are conceptual diagrams that show the status of memory blocks erased using an over program. FIG. 6A shows a case where pages with addresses that logically continue are located physically in the same memory block. FIG. 6B shows a case where pages with addresses that logically continue are dispersed physically in different memory blocks.

As shown in FIG. 6A, when 8 pages having continuous LPAs LPA8 to LPA15 are included in the same memory block A, the LPAs LPA8 to LPA15 are converted with reference to a mapping table to obtain PPAs PPA5, PPA7, PPA10 to PPA112, and PPA15 to PPA17. Under control of a firmware unit, as an over program command for requesting execution of the over program, the obtained PPAs PPA5, PPA7, PPA10 to PPA112, and PPA15 to PPA17, and data patterns to be over programmed are provided to a memory unit, the over program is executed. When the over program is completely executed, the PPAs PPA5, PPA7, PPA10 to PPA112, and PPA15 to PPA17 corresponding to the LPAs LPA8 to LPA15 are erased from the mapping table.

As shown in FIG. 6A, since data is erased by executing the over program on a page, copy-back calculation does not have to be performed on other effective pages included in the same memory block as that of the page. In addition, since a physical erase operation does not have to be performed on the memory block A, memory cell fatigue may be reduced thereby extending the lifetime of the flash memory.

As shown in FIG. 6B, the continuous LPAs LPA8 to LPA15 may be dispersed and may be included in different memory blocks block 0 to block 7, respectively. For example, the LPAs LPA8 to LPA15 may be converted into PPAs PPA0s of the memory blocks block 0 to block 7, respectively. When data is erased according to a physical erase operation, the other remaining effective PPAs PPA1 to PPA31 of each of the memory blocks block 0 to block 7 are copied back to other memory blocks (not shown), a time taken to perform the copy back operation may be increased. In addition, since the physical erase operation is performed on all of the memory blocks block 0 to block 7, the lifetime of a flash memory is likely to be reduced.

According to one or more embodiments of the inventive concept, the LPAs LPA8 to LPA15 are converted to obtain the PPAs PPA0s of the memory blocks block 0 to block 7 and the over program operation is performed on PPAs PPA0s of the memory blocks block 0 to block 7. In addition, the over program is completely executed, the PPAs PPA0s of the memory blocks block 0 to block 7, which correspond to the LPAs LPA8 to LPA15, are erased from the mapping table.

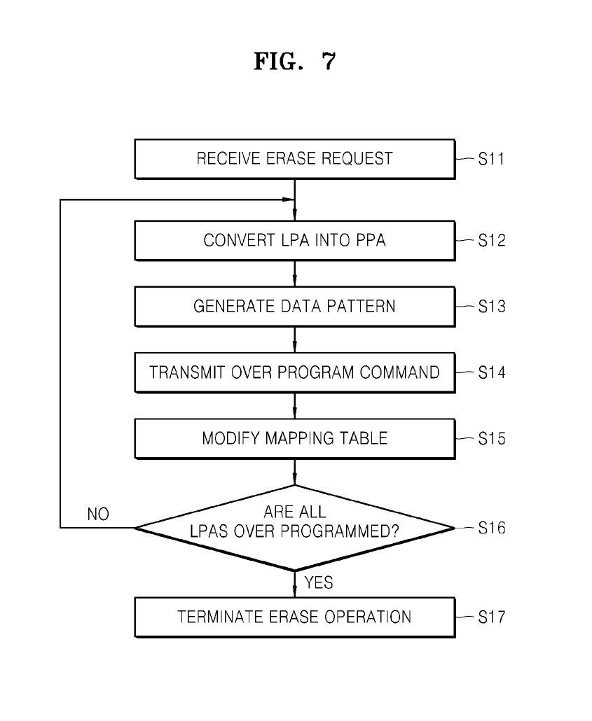

FIG. 7 is a flowchart summarizing a method of operating a flash memory device according to an embodiment of the inventive concept. As shown in FIG. 7, a data erase request directed to requested page data (including least one page of data) stored in the flash memory device is received from an external host (S11). Together with the data erase request, an LPA related to (i.e., logically identifying) the requested page data to be erased may be received.

The flash memory device performs the requested erase operation using an over program operation that uses one or more over program data patterns to effectively over program on a page-by-page basis the requested page data in response to the received erase request. To this end, the flash memory device converts a LPA of the requested page data into a corresponding PPA by referencing a mapping table, for example, (S12) and generates an over program data pattern that is provided to a page on which an over program is to be executed (S13). An over program command is transmitted together with the PPA and the over program data pattern to a memory unit (S14) so as to over program the requested page data.

After the over program operation has been executed on the requested page data, the mapping table is modified to properly updates its information (S15). The mapping table may be modified by erasing mapping data indicating relationship information between the LPA and the PPA. When data is programmed in a memory unit, the relationship information (i.e., the mapping data) between the LPA and the PPA is stored in the mapping table, wherein the LPA is used to determine a location of the data from outside the flash memory device and the PPA indicates a position of a physical space of the memory unit where data is recorded. In addition, since an over programmed page corresponds to a page from which data is erased, as viewed from outside the flash memory device, the mapping data corresponding to the over programmed page is erased from the mapping table.

The above-described operations may be sequentially performed on a page basis. And therefore it may be determined whether the over program has been completely executed for all LPAs associated with the requested page data (S16). When the over program is not complete for at least one page of the requested page data, the over program continues to the next page (S16=N0). When the over program is complete for all pages (S16=YES), the erase operation is terminated (S17) and information indicating that the erase operation is terminated may be provided to an external host.

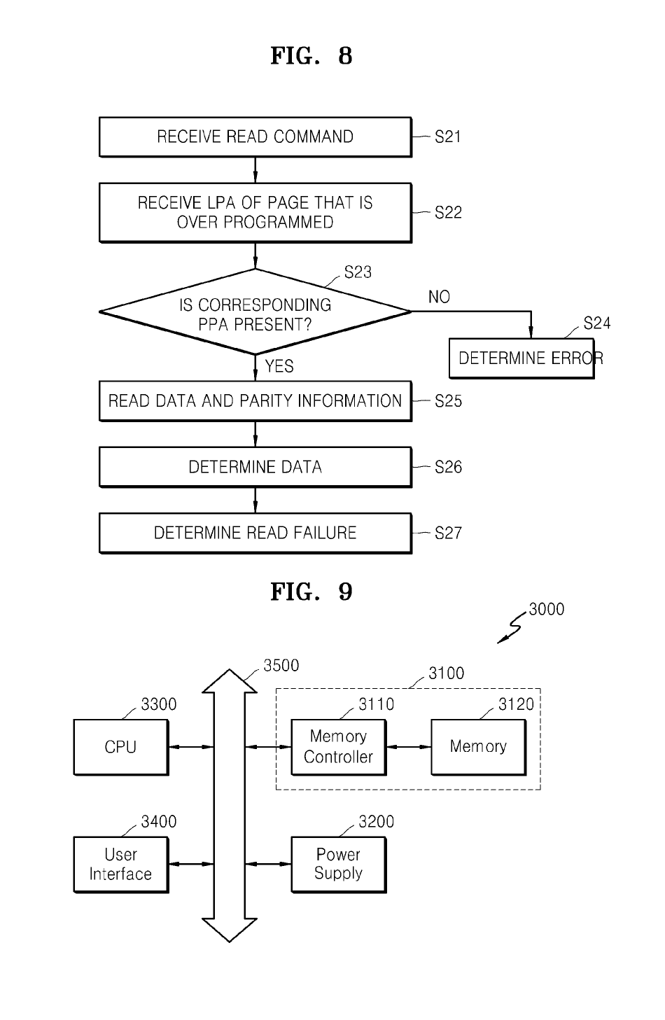

FIG. 8 is a flowchart summarizing a method of operating a flash memory device according to another embodiment of the inventive concept. With regard to FIG. 8, pages that are requested to be erased by an external host include a page on which an erase operation is performed. As shown in FIG. 8, a read command is received from an external host (S21) and simultaneously, a LPA of a page to be requested to be read is received (S22).

A flash memory device converts the received LPA into a PPA with reference to a mapping table. To this end, it is determined whether a PPA corresponding to the LPA is present by using mapping data stored in the mapping table (S23). As described above, when a page to be erased is over programmed, the mapping data including information of the PPA corresponding to the over programmed LPA may be erased from the mapping table. According to the determination result, when the PPA corresponding to the received LPA is not present, it is determined that a corresponding request has an error (S24) and information indicating this situation may be provided to an external controller.

According to the determination result, when the PPA corresponding to the received LPA is present, a page corresponding to the PPA is selected and data and parity information that are stored in the page are read (S25). The read data and parity information are provided to a determination unit of the flash memory device and it is determined whether the read operation of data has failed or passed by using a data verification operation with the data and parity information (S26). When the page is an over programmed page, the data and parity information are changed by the over program and thus, the read operation with the data and parity information fails. According to the data verification operation, the determination unit may determine that the read operation has failed (S27) and may provide information indicating the failure to an external controller.

FIG. 9 is a block diagram of a memory system 3000 including a flash memory device 3100 according to another embodiment of the inventive concept. Referring to FIG. 9, the memory system 3000 may include the flash memory device 3100, a power supply 3200, a central processing unit (CPU) 3300, and a user interface 3400, which are connected to each other through a system bus 3500. The flash memory device 3100 may include a memory controller 3110 for controlling a memory operation and a memory 3120 for performing the memory operation such as program, read, and erase operations under control of the memory controller 3110.

The CPU 3300 provides a request signal for performing the memory operation to the flash memory device 3100 and provides data and/or an address for accessing the memory 3120 to the flash memory device 3100. The flash memory device 3100 controls the memory operation in response to various signals from the CPU 3300. According to the embodiment illustrated in FIG. 9, the CPU 3300 provides an erase request of at least page and a logical address of a page to be erased to the flash memory device 3100. The memory controller 3110 of the flash memory device 3100 generates an over program command for executing an over program of the memory 3120 in response to the erase request from the CPU 3300 and converts the logical address into a physical address with reference to a mapping table. The over program command may be formed as a combination of various instructions and may be formed with substantially same combination of instructions as a general program command. The memory 3120 over programs the page by using the over program command and the physical address.

Although not illustrated, it will be obvious to one of ordinary skill in the art that a memory system according to one or more embodiments of the inventive concept may further include an application chipset, a camera image processor (CIS), a mobile dynamic random access memory (DRAM), or the like.

While the inventive concept has been particularly shown and described with reference to exemplary embodiments thereof, it will be understood that various changes in form and details may be made therein without departing from the scope of the following claims.

What is claimed is:

1. A method of operating a flash memory device, the method comprising:
receiving an erase request from an external host indicating requested page data, wherein at least a portion of the requested data page has been previously programmed;
converting a logical page address (LPA) associated with the requested data page into a corresponding physical page address (PPA);
generating an over program data pattern for an over program operation; and
executing the over program operation on the requested data page using the PPA to change a threshold voltage distribution for at least one memory cell of the requested page data in accordance with the over program data pattern.

2. The method of claim 1, wherein the at least one memory cell is a multi-level memory cell (MLC).

3. The method of claim 1, wherein over program data pattern is determined in relation to at least one of the over program operation, and the threshold voltage distribution for the at least one memory cell.

4. The method of claim 1, wherein the requested page data includes a plurality of pages, and the performing of the over program operation is iteratively performed on a page basis for each one of the plurality of pages.

5. The method of claim 1, wherein the flash memory device comprises a flash memory and a memory controller configured to control the operation of the flash memory, and the memory controller performs the converting of the LPA into the corresponding PPA and the generating of the over program data pattern.

6. The method of claim 5, further comprising:
generating an over program command causing the execution of the over program operation in the memory controller in response to the erase request; and
transferring the over program command, the PPA, and the over program data pattern are provided from the memory controller to the flash memory.

7. The method of claim 1, wherein the converting of the LPA into a corresponding PPA comprises, using the LPA to reference a mapping table storing mapping data.

8. The method of claim 1, further comprising updating the mapping data in the mapping table following execution of the over program operation.

9. The method of claim 5, wherein the flash memory comprises a plurality of memory blocks, each one of the plurality of memory blocks comprises a plurality of pages, and the requested page data includes at least one page in a single one of the plurality of memory blocks.

10. The method of claim 5, wherein the flash memory comprises a plurality of memory blocks, each one of the plurality of memory blocks comprises a plurality of pages, and the requested page data includes at least one page in at least two of the plurality of memory blocks.

11. The method of claim 5, wherein the flash memory comprises a memory cell array configured to separately store data and parity information derived from the data, and the executing of the over program comprises using the PPA to change a first threshold voltage distribution for a first memory cell of the requested page data and a second threshold voltage distribution for a second memory cell of parity information of the requested page data.

12. The method of claim 11, further comprising:
receiving a read request directed to the requested page data following the execution of the over program operation from the external host;
in response to the read request, obtaining read data from the requested page data and obtaining corresponding read parity data derived from the read data; and
determining whether the read data and the read parity data are properly correlated in accordance with an established parity relationship.

13. The method of claim 12, further comprising:
providing an indication that read data and the read parity data are not correlated in accordance with the established parity relationship.

14. A flash memory device comprising:
a flash memory comprising a memory cell array of flash memory cell comprising a plurality of memory blocks, wherein each of the plurality of memory blocks comprises a plurality of pages; and
a memory controller that receives an erase request includes a logical page address (LPA) from an external host indicating requested page data wherein at least a portion of the requested data page has been previously programmed in the memory cell array, generates a physical page address (PPA) corresponding to the LPA, determining an over program data pattern for an over program operation, and controlling the execution of the over program operation on the requested data page using the PPA to change a threshold voltage distribution for at least one memory cell of the requested page data in accordance with the over program data pattern.

15. The flash memory device of claim 14, wherein the memory controller includes a mapping table that stores mapping data used to convert the LPA to the PPA.

16. The flash memory device of claim 15, wherein the at least one memory cell is a multi-level memory cell (MLC).

17. The flash memory device of claim 15, wherein the over program data pattern is determined in relation to at least one of the over program operation, and the threshold voltage distribution for the at least one memory cell.

18. The flash memory device of claim 14, wherein the memory controller comprises a flash translation layer (FTL) that controls operation the flash memory by generating an over program command and the over program data pattern.

19. The flash memory device of claim 18, wherein the FTL is embodied at least on part by firmware in the memory controller.

20. The flash memory device of claim 19, wherein the memory controller comprises:
a register that stores the over program command;
a data pattern generator that generates the over program data pattern; and
an address converting unit that converts the LPA into the PPA.
